(19) United States
(12) Patent Application Publication
(10) Pub. No.: US 2003/0101804 A1
(43) Pub. Date: Jun. 5, 2003

(54) Ultrasonic meter to detect pipeline corrosion and buildup

(76) Inventor: Klaus Joachim Zanker, Houston, TX (US)

Correspondence Address: CONLEY ROSE, P.C., P. O. BOX 3267, HOUSTON, TX, 77253-3267, US

(21) Appl. No.: 09/997,376

(22) Filed: Nov. 30, 2001

(51) Int. Cl. G01B 5/28

(52) U.S. Cl. 73/105; 73/597

(57) ABSTRACT

A method is disclosed for determining the amount of surface discontinuity on the interior surface of a pipeline that could result, for example, from corrosion or from dirt and crud buildup. As dirt and other collateral material collect along an interior pipeline wall, or as the pipeline wall corrodes, the flow profile for the gas flow traveling through the pipeline changes. By measuring the ratio of the flow velocity near the interior of the pipeline to that near the perimeter of the pipeline over time, the relative roughness of the inner pipeline surface can be determined.

### CROSS-REFERENCE TO RELATED APPLICATIONS

Not Applicable

### STATEMENT REGARDING FEDERALLY SPONSORED RESEARCH OR DEVELOPMENT

Not Applicable.

### BACKGROUND OF THE INVENTION

1. Field of the Invention

A disclosed embodiment of the invention relates generally to the detection of corrosion and buildup in a gas pipeline. Even more particularly, a disclosed embodiment of the invention relates to the measurement over time of the amount of corrosion or buildup in a pipeline by an ultrasonic meter.

2. Description of the Related Art

After a hydrocarbon such as natural gas has been removed from the ground, the gas stream is commonly transported from place to place via pipelines. As is appreciated by those of skill in the art, it is desirable to know with accuracy the amount of gas in the gas stream. Particular accuracy for gas flow measurements is demanded when gas (and any accompanying liquid) is changing hands, or “custody.” Even where custody transfer is not taking place, however, measurement accuracy is desirable.

Gas flow meters have been developed to determine how much gas is flowing through the pipeline. An orifice meter is one established meter to measure the amount of gas flow. Certain drawbacks with this meter existed, however. More recently, another type of meter to measure gas was developed. This more recently developed meter is called an ultrasonic flow meter.

FIG. 1A shows an ultrasonic meter suitable for measuring gas flow. A spoolpiece suitable for placement between sections of gas pipeline, has a predetermined size and thus defines a measurement section. A pair of transducers 120 and 130, and their respective housings 125 and 135, are located along the length of the spoolpiece. A path 110, sometimes referred to as a “chord” exists between transducers 120 and 130 at an angle θ to a centerline 105. The position of transducers 120 and 130 may be defined by this angle, or may be defined by a first length L measured between transducers 120 and 130, a second length X corresponding to the axial distance between points 140 and 145, and a third length D corresponding to the pipe diameter. Distances X and L are precisely determined during meter fabrication. Points 140 and 145 define the locations where acoustic signals generated by transducers 120 and 130 enter and leave gas flowing through the spoolpiece 100 (i.e. the entrance to the spoolpiece bore). In most instances, meter transducers such as 120 and 130 are placed a specific distance from points 140 and 145, respectively, regardless of meter size (i.e. spoolpiece size). A fluid, typically natural gas, flows in a direction 150 with a velocity profile 152. Velocity vectors 153-158 indicate that the gas velocity through the spool piece increases as centerline 105 of the spoolpiece is approached.

Transducers 120 and 130 are ultrasonic transceivers, meaning that they both generate and receive ultrasonic signals. “Ultrasonic” in this context refers to frequencies above about 20 kilohertz. Typically, these signals are generated and received by a piezoelectric element in each transducer. Initially, D (downstream) transducer 120 generates an ultrasonic signal that is then received at, and detected by, U (upstream) transducer 130. Some time later, U transducer 130 generates a reciprocal ultrasonic signal that is subsequently received at and detected by D transducer 120. Thus, U and D transducers 120 and 130 play “pitch and catch” with ultrasonic signals 115 along chordal path 110. During operation, this sequence may occur thousands of times per minute.

The transit time of the ultrasonic wave 115 between transducers U 130 and D 120 depends in part upon whether the ultrasonic signal 115 is traveling upstream or downstream with respect to the flowing gas. The transit time for an ultrasonic signal traveling downstream (i.e. in the same direction as the flow) is less than its transit time when traveling upstream (i.e. against the flow). In particular, the transmit time t₁, of an ultrasonic signal traveling against the fluid flow and the transit time t₂ of an ultrasonic signal travelling with the fluid flow may be defined:

$$\begin{matrix}{t}_{1} = \frac{L}{c - V \frac{x}{L}} & ( 1 ) \\ {t}_{2} = \frac{L}{c + V \frac{x}{L}} & ( 2 )\end{matrix}$$

where,

c=speed of sound in the fluid flow;

V=axial velocity of the fluid flow;

L=acoustic path length;

X=axial component of L;

VX/L=component of V along the acoustic path;

t₁=transmit time of the ultrasonic signal against the fluid flow;

t₂=transit time of the ultrasonic signal with the fluid flow.

The upstream and downstream transit times can be used to calculate the average velocity along the signal path by the equation:

$$V = \frac{{L}^{2}}{2 x} \frac{{t}_{1} - {t}_{2}}{{t}_{1} {t}_{2}} \qquad ( 3 )$$

The upstream and downstream travel times may also be used to calculate the speed of sound in the fluid flow according to the equation:

$$c = \frac{L}{2} \frac{{t}_{1} + {t}_{2}}{{t}_{1} {t}_{2}} \qquad ( 4 )$$

to a close approximation:

$$\begin{matrix}V = \frac{{c}^{2} Δ t}{2 x} \\ where , & ( 5 ) \\ Δ t = {t}_{1} - {t}_{2} & ( 6 )\end{matrix}$$

So the velocity v is directly proportioned to Δt.

Given the cross-section measurements of the meter carrying the gas, the average velocity over the area of the gas may be used to find the quantity of gas flowing through the spoolpiece. Alternately, a meter may be designed to attach to a pipeline section by, for example, hot tapping, so that the pipeline dimensions instead of spoolpiece dimensions are used to determine the average velocity of the flowing gas.

In addition, ultrasonic gas flow meters can have one or more paths. Single-path meters typically include a pair of transducers that projects ultrasonic waves over a single path across the axis (i.e. center) of the spoolpiece. In addition to the advantages provided by single-path ultrasonic meters, ultrasonic meters having more than one path have other advantages. These advantages make multi-path ultrasonic meters desirable for custody transfer applications where accuracy and reliability are crucial.

Referring now to FIG. 1B, a multi-path ultrasonic meter is shown. Spool piece 100 includes four chordal paths A, B, C, and D at varying levels through the gas flow. Each chordal path A-D corresponds to two transceivers behaving alternately as a transmitter and receiver. Also shown is an electronics module 160, which acquires and processes the data from the four chordal paths A-D. This arrangement is described in U.S. Pat. No. 4,646,575, the teachings of which are hereby incorporated by reference. Hidden from view in FIG. 1B are the four pairs of transducers that correspond to chordal paths A-D.

The precise arrangement of the four pairs of transducers may be more easily understood by reference to FIG. 1C. Four pairs of transducer ports are mounted on spool piece 100. Each of these pairs of transducer ports corresponds to a single chordal path of FIG. 1B. A first pair of transducer ports 125 and 135 including transducers 120 and 130 is mounted at a non-perpendicular angle θ to centerline 105 of spool piece 100. Another pair of transducer ports 165 and 175 including associated transducers is mounted so that its chordal path loosely forms an “X” with respect to the chordal path of transducer ports 125 and 135. Similarly, transducer ports 185 and 195 are placed parallel to transducer ports 165 and 175 but at a different “level” (i.e. a different radial position in the pipe or meter spoolpiece). Not explicitly shown in FIG. 1C is a fourth pair of transducers and transducer ports. Taking FIGS. 1B and 1C together, the pairs of transducers are arranged such that the upper two pairs of transducers corresponding to chords A and B form an X and the lower two pairs of transducers corresponding to chords C and D also form an X.

Referring now to FIG. 1B, the flow velocity of the gas may be determined at each chord A-D to obtain chordal flow velocities. To obtain an average flow velocity over the entire pipe, the chordal flow velocities are multiplied by a set of predetermined constants. Such constants are well known and were determined theoretically.

This four-path configuration has been found to be highly accurate and cost effective. Nonetheless, other ultrasonic meter designs are known. For example, other ultrasonic meters employ reflective chordal paths, also known as “bounce” paths.

Despite the advantages of an ultrasonic meter over previous flow meters such as orifice meters, there nonetheless is a constant desire to improve the accuracy and longevity of ultrasonic meters. There is thus a need for a meter that is capable of more accurate measurements. Ideally, such a meter would remain accurate over a long period of time and would need little maintenance. It would also be desirable if this meter could be made by only minimal changes to known flow meters.

### SUMMARY OF THE INVENTION

Disclosed embodiments of the invention include a method to determine the amount of material buildup on the interior surface of a pipeline. This method includes measuring in a pipeline first and second gas flow velocities, one near the centerline of the pipeline and one closer to the perimeter of said pipeline. Some appreciable time later, third and fourth gas flow velocities are measured at about the same locations. These measurements are then compared as, by example, comparing the ratio of the first and second flow measurements to the ratio of the third and fourth flow measurements. The comparison provides an indication of the pipe roughness on the interior surface of the pipeline. Such an indication can be used to determine when maintenance should be performed on the meter, such as having it re-calibrated or cleaned.

The invention comprises a combination of features and advantages that enable it to overcome various problems of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1A is a cut-away top view of an ultrasonic gas flow meter.

FIG. 1B is an end view of a spoolpiece including chordal paths A-D.

FIG. 1C is a top view of a spoolpiece housing transducer pairs.

FIG. 2 is a graph illustrating a velocity ratio/pipe roughness relationship.

FIG. 3 is a diagram of flow profiles corresponding to a clean pipeline and a corroded or crud filled pipeline.

### DETAILED DESCRIPTION OF THE PREFERRED EMBODIMENT

A number of different parameters may be measured by an ultrasonic meter. For example, the meter may measure mean flow velocity, standard deviation (Std DLTT) for the differences in upstream and downstream travel times, and gain. The mean flow velocity represents the average speed of the gas flowing through a meter. The speed of sound measurement represents the speed of sound for a particular gas flowing through the meter. “Standard deviation” is a mathematical term denoting a measure of the dispersion or variation in a distribution, equal to the square root of the arithmetic mean of the squares of the deviations from the arithmetic mean. Hence, changes in the standard deviation for the differences in upstream and downstream travel times is an indication of the variability in ultrasonic signal travel times. The gain, also called amplifier gain, is a measure of the amount of attenuation or weakening of a transmitted ultrasonic signal.

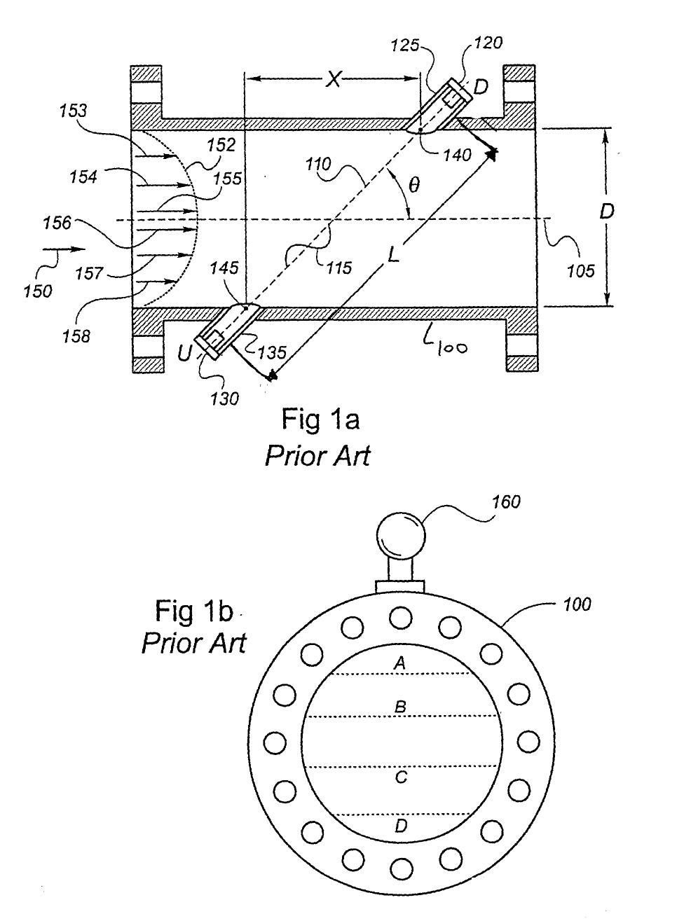

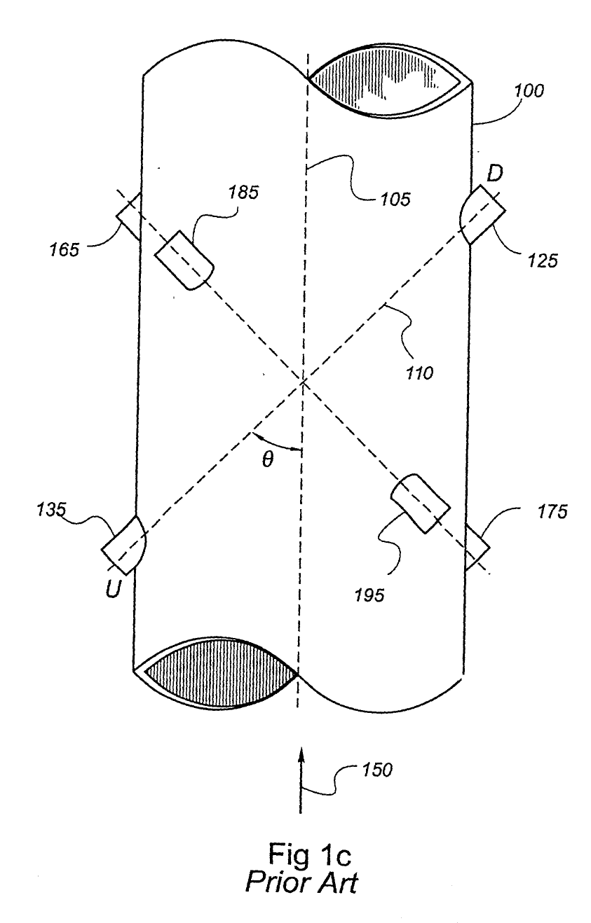

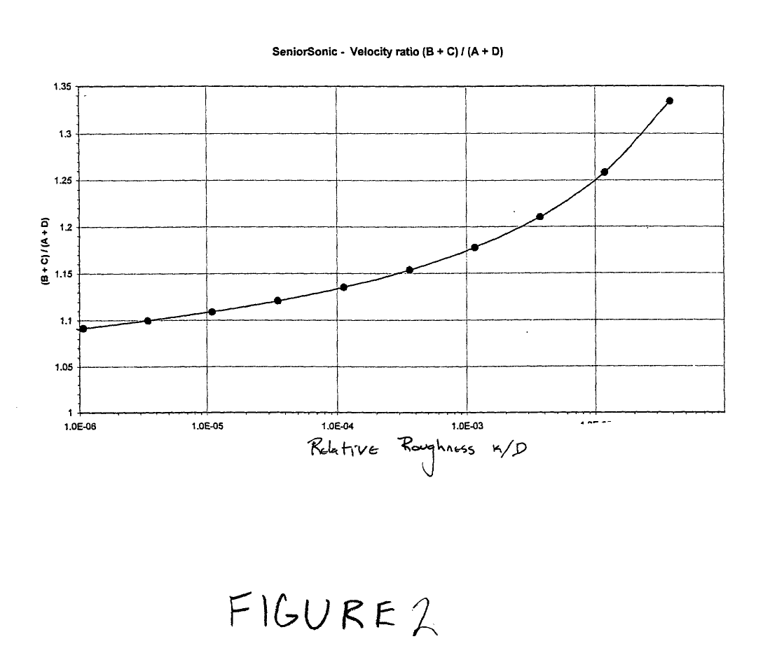

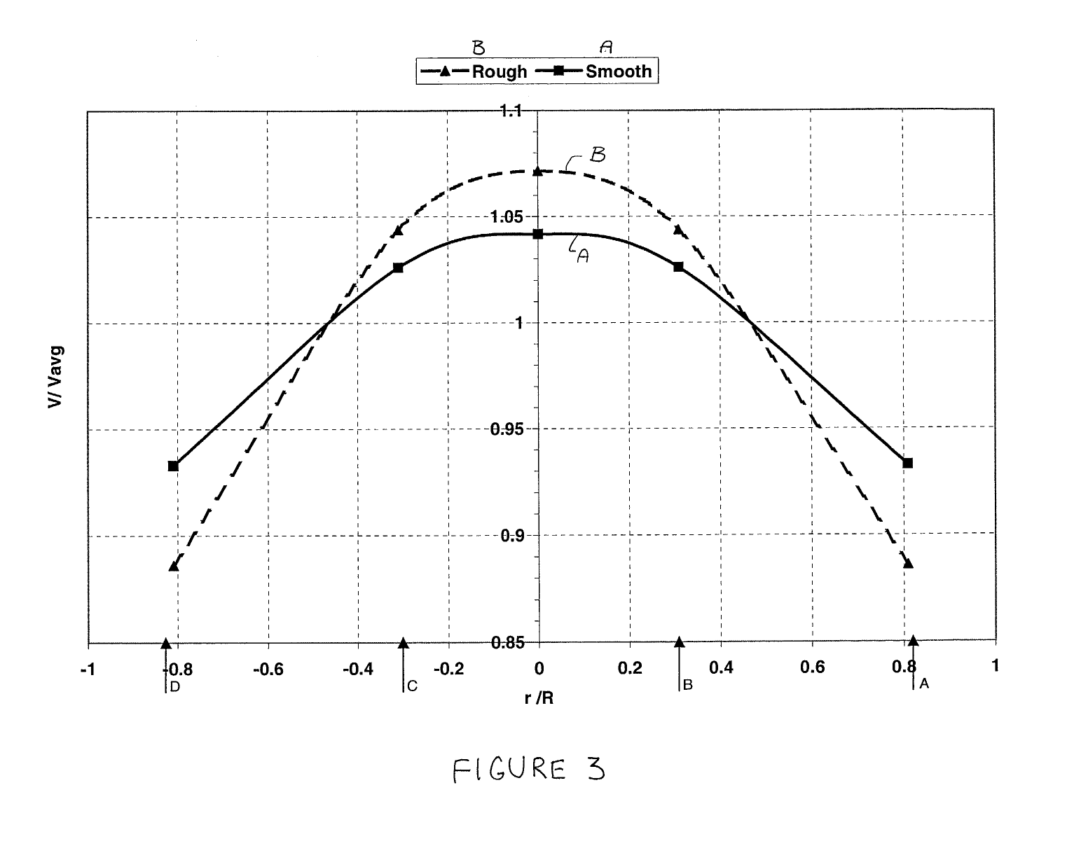

The accuracy of the measurements for these parameters is relatively reliable when the ultrasonic meter is new, but there exist doubts regarding the accuracy of the meter in time with corrosion, deposits and the buildup of other material and crud on the inner surface of the pipeline. FIG. 3 shows a graph showing the velocity profiles of a fluid flowing through a pipe having a smooth inner surface and a pipe having a rough inner surface (from corrosion or build-up). Along the Y-axis of the graph is the ratio of the measured flow divided by average flow (V/Vavg). Along the X-axis of the graph is the measurement location in the pipeline divided by the full radius of the pipe or spoolpiece (r/R). Also shown are the measurement locations in the pipeline for chords A, B, C, and D. A first curve, labeled curve A, corresponds to the flow profile of a fluid in a smooth pipe. A second curve, labeled curve B, corresponds to the flow profile of a fluid in a rough pipe. As shown in FIGS. 1 and 3 (curve A), once a gas flow has stabilized in the pipeline it has a faster flow toward the center of the pipeline than close to the pipeline wall. This generally occurs because friction between the gas and the pipeline wall slows the gas near the pipeline wall. The gas furthest from the pipeline wall (i.e. the gas traveling along the centerline of the pipeline) is least subject to friction effects from the pipeline wall. The buildup of material inside and around the inner surface of the pipe, or the corrosion of the pipeline wall, increases the pipe roughness and therefore increases friction and interference between the gas flow and the inner surface of the pipeline wall. This increased friction changes the velocity profile of the gas flow, making the flow peakier. In other words, discontinuities along the inner pipeline surface creates a greater difference in relative flow velocities between gas flow at the center of the pipe and the gas flow near the pipeline wall, as shown in FIG. 3 (curve B).

Such an increase in the central velocity vectors relative to the perimeter velocity vectors can be detected by a multi-chord ultrasonic meter. In particular, the velocity ratio of the center chord or chords (i.e. inner) as compared to the chord or chords relatively closer to the pipeline wall (i.e. outer) provides an indication of gas flow profile peakiness. In the four-chord ultrasonic meter shown in FIGS. 1A-1C, the flow profile peakiness can be detected by the velocity ratio:

(V_{B}+V_{C})/(V_{A}+V_{D}) (7)

where,

V_{A}=velocity along uppermost chord A

V_{B}=velocity along second to top chord B

V_{C}=velocity along second to bottom chord C; and

V_{D}=velocity along lowermost chord D.

FIG. 2 is a graph of the velocity ratio to relative roughness of the pipeline wall. Along the X-axis is shown the hydraulic roughness (k) divided by pipeline diameter (D). Hydraulic roughness is expressed by the head loss in the pipe and reflects the roughness of the inner surface of the pipe. The hydraulic roughness divided by pipeline diameter therefore indicates the relative roughness of the interior of the pipe. Along the Y-axis is shown the velocity ratio (V_{B}+V_{C})/(V_{A}+V_{D}).

If the velocity ratio is monitored with time, the tendency of the velocity ratio to increase is a sign that the pipe roughness is also increasing. For example, a statistically significant amount of buildup along the inner walls of the pipeline might occur in a few months time or even as little as four weeks. Suitable periods to check for discontinuities along the inner wall of the pipeline might therefore be four weeks, three months, yearly, or as often as thought necessary.

The amount of pipe roughness may be determined by reference to a graph such as shown in FIG. 2. The change in roughness can be used to make rational decisions on the need for maintenance, such as to clean or re-calibrate the meter, or to replace sections of the pipeline.

Another useful parameter to determine corrosion or buildup in the pipeline is asymmetry in the fluid flow. For example, a corrosive liquid in the fluid flow may affect only one portion of the pipeline interior, resulting in asymmetric flow of the fluid through the pipeline from discontinuities in the pipeline's inner wall. Alternately, a fluid flow may have a greater proportion of contaminants in one part (e.g. lower) than in another, leading to greater buildup in one part of the pipeline.

The symmetry of the fluid flow may be determined by comparing inner flow to outer flow. For example, the symmetry of the fluid flow in a four-chord meter can be determined by measuring the mean flow velocity at an inner pipeline location, such as at chord B or C. The mean flow velocity at an outer chord location may then be determined by measurement at chords A or D. Thus, the comparison may be A to B, A to C, B to D, or C to D. Each of these measurements may then be compared to each other to determine relative roughness at the upper portion of the pipe to the lower portion. Alternately, the asymmetry measurement could be B/(A+D), C/(A+D), (B+C)/A, or (B+C)/D. A change in these relationships with time indicates the possibility of uneven corrosion or buildup inside the pipeline. Of course, a four-chord arrangement is not necessary to determine flow symmetry, and other chordal configurations could also be used for other designs of ultrasonic meters. Meters with a different number or arrangement of chords would require analogous measurements to determine flow symmetry.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. For example, it is not necessary that a four-chord meter with parallel chords is required, although this is preferred. Any chord that is close to the center of the pipe (as viewed from an end view) may be compared to any chord that is relatively closer to the pipe wall (as viewed from an end view) to determine pipe roughness. Additional chord measurements may then be compared. It is simply a matter of sensitivity. Accordingly, the scope of protection is not limited to the embodiments described herein, but is only limited by the claims that follow, the scope of which shall include all equivalents of the subject matter of the claims.

What is claimed is:

1. A method to determine changes in the interior surface of a pipeline over time, comprising:
a) measuring a first gas flow velocity for a gas flow in said pipeline, said first gas flow velocity being measured proximate the centerline of the pipeline;
b) measuring in said pipeline a second gas flow velocity relatively closer to the pipe wall;
c) measuring a third gas flow velocity proximate the centerline of the pipeline at a time later than measuring said first gas flow velocity;
d) measuring said fourth gas flow velocity relatively closer to the perimeter of said pipeline at a time later than measuring said second gas flow velocity;
e) comparing said first, second, third, and fourth velocity measurements to provide an indication of pipe roughness on said interior surface of said pipeline.

2. The method of claim 1, wherein said first gas flow velocity and said third flow velocity are measured at the same location in said pipeline and further wherein said second gas flow velocity and said further gas flow velocity are measured at the same location.

3. The method of claim 2, wherein said step of comparing includes inferring a pipe roughness measurement based on a known correlation between said first, second, third and fourth velocity measurements and pipe roughness.

4. The method of claim 2, wherein said third measurement is made more than twenty-eight days after said first measurement.

5. The method of claim 2, wherein said step of comparing includes determining a first ratio for said first and second measurements and a second ratio for said third and fourth measurements.

6. The method of claim 2, further comprising the measurement of a fifth gas flow velocity proximate to said centerline and the measurement of a sixth gas flow velocity relatively closer to the perimeter of the pipeline.

7. The method of claim 6, further comprising the measurement of a seventh gas flow velocity proximate to said centerline and the measurement of an eighth gas flow velocity relatively closer to the perimeter of the pipeline, wherein said seventh gas flow velocity measurement is made after said fifth gas flow velocity measurement and said eighth gas flow velocity measurement is made after said sixth gas flow velocity measurement.

8. The method of claim 2, wherein said steps of measuring are accomplished by an ultrasonic meter.

9. The method of claim 2, further comprising:
f) providing an indication based on said comparison whether re-calibration of said ultrasonic meter is required.

10. The method of claim 2, further comprising:
(f) providing an indication based on said comparision whether cleaning of said ultrasonic meter is required.

11. The method of claim 6, further comprising:
(f) determining the asymmetry of said gas flow by comparing said first gas flow velocity to said second gas flow velocity and by comparing said fifth gas flow velocity to said sixth gas flow velocity.

12. An ultrasonic meter, comprising:
a housing defining a longitudinal axis;
a first set of transducers positioned to create a first chord relatively closer to said longitudinal axis of said housing;
a second set of transducers positioned to create a second chord relatively further away from said longitudinal axis of said housing;
a processor programmed to compute first and second gas flow velocities along said first chord and third and fourth gas flow velocities along said second chord, and to compare said first, second, third, and fourth velocity measurements to provide an indication of pipe roughness on said interior surface of said pipeline.

13. The ultrasonic meter of claim 12, wherein said indication of pipe roughness is derived from a predetermined correlation between said first, second, third and fourth velocity measurements and pipe roughness.

14. The ultrasonic meter of claim 12, wherein said second measurement is made more than twenty eight days after said first measurement.

15. The ultrasonic meter of claim 12, wherein said fourth measurement is made more than ninety days after said first measurement.

16. The ultrasonic meter of claim 12, wherein said second measurement is made more than one year after said first measurement.

17. The ultrasonic meter of claim 12, wherein said step of comparing includes determining a first ratio for said first and third measurements and a second ratio for said second and fourth measurements.

18. The ultrasonic meter of claim 12, wherein said processor provides an indication based on said comparison whether to re-calibrate or clean said ultrasonic meter.

19. The ultrasonic meter of claim 12, wherein said asymmetry of said flow is computed by comparison of said first gas flow velocity with said third gas flow velocity.

20. An ultrasonic meter, comprising:
an ultrasonic meter housing defining a center;
means for measuring a first set of times of flight for ultrasonic signals proximate said center of said housing;
means for measuring a second set of times of flight for an ultrasonic signals relatively further away from said center than said first set;
means for computing a degree of discontinuities along an interior of a pipeline connected to said ultrasonic meter.
